(19) United States
(12) Patent Application Publication
(10) Pub. No.: US 2022/0206776 A1
(43) Pub. Date: Jun. 30, 2022

(54) EDGE SYSTEM AND METHOD FOR CONTROLLING EDGE SYSTEM

(71) Applicant: LATONA, INC., Tokyo (JP)

(72) Inventors: Satoshi TAKAHASHI, Tokyo (JP); Antoine SAUVAGE, Tokyo (JP); Yosuke KAKIUCHI, Tokyo (JP)

(73) Assignee: LATONA, INC., Tokyo (JP)

(21) Appl. No.: 17/595,972

(22) PCT Filed: Apr. 16, 2020
(86) PCT No.: PCT/JP2020/016782

§ 371 Date: Nov. 30, 2021

(30) Foreign Application Priority Data
Jul. 2, 2019 (JP) 2019-123697

(51) Int. Cl. G06F 8/61; G06F 9/455; H04W 8/24

(52) U.S. Cl. CPC G06F 8/63; G06F 2009/45595; H04W 8/245; G06F 9/45558

(57) ABSTRACT

An edge system configured by an edge terminal that implements a predetermined function by operating a container using a hardware resource logically allocated by an orchestration technique, wherein the edge terminal is configured to acquire a corresponding image from an image registry based on predetermined setting information, and perform a setting process of deploying to the edge terminal using the acquired image, the edge terminal further includes a device having a predetermined function, and the setting information includes information related to the device.

### TECHNICAL FIELD

The present invention relates to an edge system using a container orchestration technique, a method for controlling an edge system, a computer program used to control an edge system, and a recording medium storing the computer program.

### BACKGROUND ART

There is known a system in which information related to a work device performing a predetermined work in a local environment such as a factory and a construction site is acquired by a sensor, and monitoring of acquired sensor information and control of the work device based on the sensor information are performed from a network side, that is, from a cloud. However, when the number of the work device or the sensor is large in this type of system, problems such as an increase in network load and a delay in processing time occur as a data amount of the sensor information and processing load increase. There are also concerns about information security and the like. Therefore, an edge system that processes sensor information in a local environment, that is, at an end (edge) of a network, for example, in a factory, has been studied.

Meanwhile, in recent years, a technique of acquiring and analyzing sensor information in a local environment has attracted attention, and is called edge computing or mobile edge computing (MEC). In this case, a device arranged in the local environment is called an edge terminal or an MEC. In order to implement a large number of functions in the edge terminal, a plurality of applications are operated on an operating system (OS) installed on a host PC. However, when operating the plurality of applications at the same time, it is necessary to share system resources in the OS among the applications, and therefore, application design must be changed for each OS, which imposes a heavy development burden.

Therefore, there is known a technique of creating a logical section on the OS of the edge terminal and deploying in the section a container application that summarizes an environment required for operating the application in addition to the application itself. According to this technique, the resources on the OS can be logically separated and used by a plurality of containers. Therefore, an OS dependency of the application design can be lowered, and a burden of system development can be reduced. Such a container technique is implemented by container management software installed on the OS. Examples of the container management software include the Docker and the like (for example, Patent Literature 1).

In recent years, with evolution of the container technique and a demand for system redundancy, network connection, storage area, and host PC settings have become complicated, and a need for scheduling a plurality of container applications has increased. Therefore, development of an orchestration tool that automatically performs these settings and integrally manages the container applications is in progress.

By using the orchestration tool, it is possible to easily deploy, execute, manage, and schedule a plurality of container applications, so that the burden of system development can be further reduced. Examples of known container orchestration tools include Kubernetes, Apache Mesos, and the like.

### CITATION LIST

### Patent Literature

Patent Literature 1: International Publication No. WO 2018/003020

### SUMMARY OF INVENTION

### Technical Problem

On the edge terminal, after installing the OS, a container engine, and the orchestration tool, it is necessary to deploy containers that perform individual controls of the above components. However, when there are a plurality of edge terminals constituting an edge system, it is necessary to perform software setting on the edge terminals during initial introduction of the edge system. Therefore, not only a large number of man-hours may be required, but also setting errors may occur since setting work is different for each component.

An object of the present invention is to solve such a problem, and the present invention can reduce the man-hours for setting the system during the initial introduction of the edge system.

### Solution to Problem

The above-mentioned problem can be solved by a system or the like having the following configuration.

That is, a system according to one aspect of the present invention is an edge system configured by an edge terminal that implements a predetermined function by operating a container using a hardware resource logically allocated by an orchestration technique, in which the edge terminal is configured to acquire a corresponding image from an image registry based on predetermined setting information, and perform a setting process of deploying to the edge terminal using the acquired image.

### ADVANTAGEOUS EFFECTS OF INVENTION

According to one aspect of the present invention, in a local environment, a setting server transfers a file required for system setting such as initial setting from an image stored in an image registry on a network to an edge terminal according to stored setting information, so that deployment is performed on the edge terminal. Here, when each edge terminal is set individually, a large number of man-hours are required. In response thereto, in the present invention, since the setting can be performed by using the setting information provided in the local environment, the edge terminal can be set without error and the man-hours can be reduced.

### BRIEF DESCRIPTION OF DRAWINGS

FIG. 1 is a block diagram showing an edge system according to a first embodiment.

FIG. 2 is a hardware configuration diagram of an MEC.

FIG. 3 is a software configuration diagram of the MEC.

FIG. 4 is a software configuration diagram of the MEC when an orchestration tool is used.

FIG. 5 is a table showing setting information of the MEC.

FIG. 6 is a flowchart showing setting control of the MEC.

FIG. 7 is a table showing a list of deployed programs.

FIG. 8 is a block diagram showing an edge system according to a second embodiment.

FIG. 9 is a block diagram showing a configuration of a multifunction device.

FIG. 10 is a table showing setting information of MECs.

FIG. 11 is a flowchart showing setting control of the MECs according to the second embodiment.

### DESCRIPTION OF EMBODIMENTS

Hereinafter, a first embodiment of the present invention will be described with reference to the drawings.

### First Embodiment

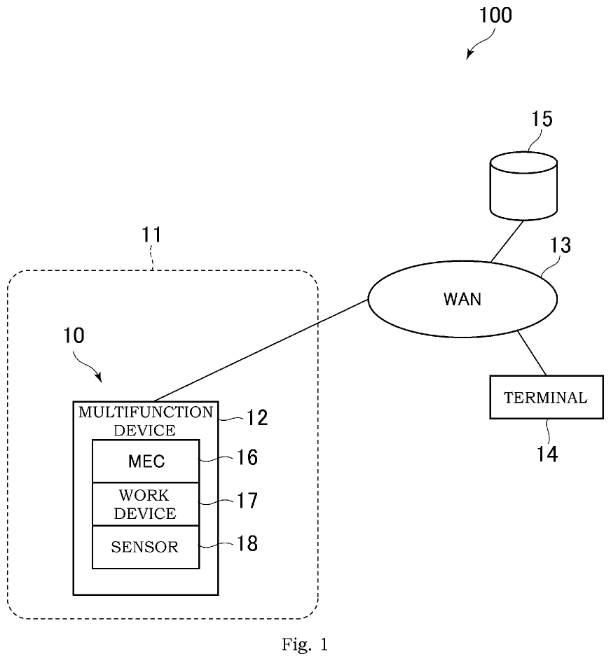

FIG. 1 is a block diagram showing a configuration of a monitoring system including an edge system according to the embodiment of the present invention. As shown in this drawing, in a monitoring system 100, an edge system 10 provided in a local environment 11 is connected to a wide area network (WAN) 13 and is configured to be able to communicate with a terminal 14 and an image registry 15 via the WAN 13.

The edge system 10 is, for example, a system configured to monitor a manufacturing process, a construction process, and the like in the local environment 11 such as a factory or a construction site, and control work devices used in these processes. The edge system 10 is configured by a multifunction device 12 that implements a plurality of functions such as communication and control, and in the present embodiment, the edge system 10 is configured by one multifunction device 12. The multifunction device 12 includes an MEC 16, a work device 17, and a sensor 18. The edge system 10 is connected to the WAN 13 by wireless communication or wired communication. The WAN 13 may be partially or wholly configured by a mobile communication network. The present embodiment illustrates a system including one multifunction device 12, but the system is not limited to such a configuration and may be a system including a plurality of multifunction devices 12.

The terminal 14 and the image registry 15 are connected to the WAN 13. The edge system 10, terminal 14, and image registry 15 can communicate with each other via the WAN 13.

The terminal 14 is a device including a display, a central processing unit (CPU), a graphics processing unit (GPU), a memory, a network interface, and the like, is connected to the edge system 10 via the WAN 13, and displays a monitoring result sent from the edge system 10. The terminal 14 is, for example, an information terminal including a display unit such as a personal computer, a smartphone, and a tablet terminal.

The image registry 15 is, for example, a general-purpose data server. As will be described later, in the MEC 16, which is a part of the multifunction device 12 that configures the edge system 10, a container is executed using a container orchestration technique. The image registry 15 stores an image of a container deployed in the MEC 16. A system environment construction tool such as bitbucket or Concourse CI may be used as a unit for implementing an orchestration tool.

The image of the container stored in the image registry 15 is sent to the edge system 10 via the WAN 13 and deployed at the MEC 16 of the multifunction device 12.

Here, the MEC 16 will be described in detail. The MEC 16 is an example of an edge terminal and controls the work device 17 and collects sensor information acquired by the sensor 18 by a container controlled by using the container orchestration technique. The MEC 16 is a device equipped with a CPU, a GPU, a memory, a network interface, and the like, and is configured to be able to execute a stored program. The MEC 16 may be configured by using a general-purpose computer or may be a dedicated terminal.

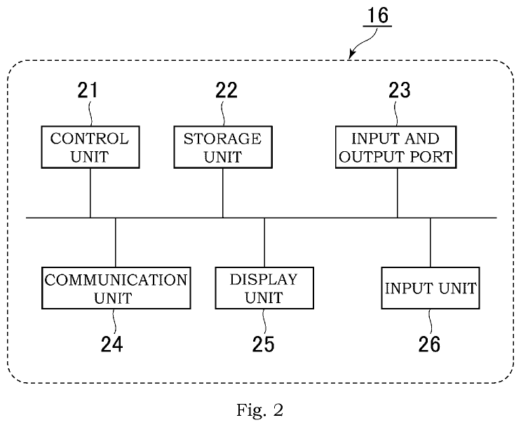

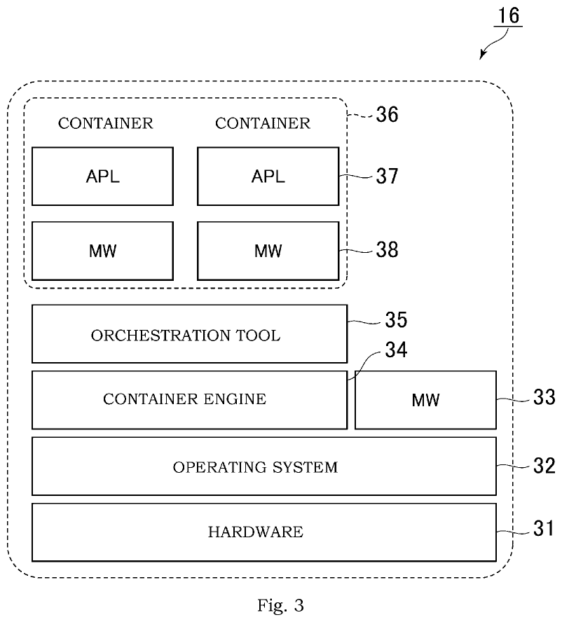

The MEC 16 includes middleware configured to implement the container orchestration technique installed on an operating system (OS). Then, in the MEC 16, a container configured to implement a predetermined function is deployed. A hardware configuration of the MEC 16 will be described later with reference to FIG. 2, and a software configuration thereof will be described with reference to FIG. 3.

The MEC 16 mainly monitors and performs machine learning on control information of the work device 17 and the sensor information acquired by the sensor 18 in the local environment 11. The MEC 16 sends a monitoring result, a trained model obtained by the machine learning, and the like to the terminal 14 via wireless communication or wired communication.

The work device 17 is a device used in one or more manufacturing processes and construction processes in the local environment 11, and varies from medium and large size devices such as a robot arm in a factory and a truck in a construction site to a small device such as a display module made of a semiconductor substrate.

The sensor 18 is a device configured to acquire information directly or indirectly related to the work device 17, such as a camera or an infrared sensor. The sensor 18 outputs the acquired sensor information to the MEC 16.

FIG. 2 is a hardware configuration diagram of the MEC 16.

The MEC 16 includes a control unit 21 that is configured by a CPU, a GPU, and the like that control the whole system, a storage unit 22 that is configured by a read only memory (ROM), a random access memory (RAM), a hard disk, a storage, or the like and stores programs, various data, and the like, an input and output port 23 that inputs and outputs data to and from an external device, a communication unit 24 that performs communication with another MEC 16, a display unit 25 that is configured by a display, an LED, a speaker, or the like and performs display according to data, and an input unit 26 that accepts input from outside. The control unit 21, the storage unit 22, the input and output port 23, the communication unit 24, the display unit 25, and the input unit 26 are configured to be able to communicate with each other by bus connection. This hardware configuration may be a hardware circuit configured to execute a predetermined function by a program used in a semiconductor circuit such as FPGA or GPU-CUDA.

FIG. 3 is a software configuration diagram of the MEC 16.

In the MEC 16, an operating system (OS) 32 such as the Linux (registered trademark) is installed on hardware 31. In the operating system 32, in addition to general-purpose middleware 33, a container engine 34 and an orchestration tool 35 that operates together with the container engine 34 are installed.

In the MEC 16, the container engine 34 and the orchestration tool 35 deploy and execute a container 36. In addition to an application (APL) 37 configured to implement a predetermined function, the container 36 includes dedicated middleware (MW) 38 that is mainly used for operation of the application 37 according to an operating specification of the container engine 34. The middleware 38 may include a library and the like.

The hardware 31 is provided with the hardware configuration shown in FIG. 2. Using these resources of the hardware 31, the MEC 16 can perform a predetermined operation.

The operating system 32 is a basic system of the software configuration in the MEC 16. The operating system 32 controls an overall operation of the MEC 16.

In general, the general-purpose middleware 33 is a functional block provided by a vendor of the operating system 32 or the like, and is a functional block for implementing basic operations such as a communication function by the communication unit 24, a display operation by the display unit 25, and input control from the input unit 26 shown in FIG. 2. More specifically, the general-purpose middleware 33 is an application framework, a database, an engine of a script-type programming language, and the like in the entire software in the MEC 16, and implements basic operations in the software configuration. The general-purpose middleware 33 may be referred to as a platform.

The container engine 34 is one of the middleware installed in the operating system 32, and is an engine that operates the container 36. Specifically, the container engine 34 allocates resources of the hardware 31 and the operating system 32 to the container 36 based on a setting included in the middleware 38 in the container 36.

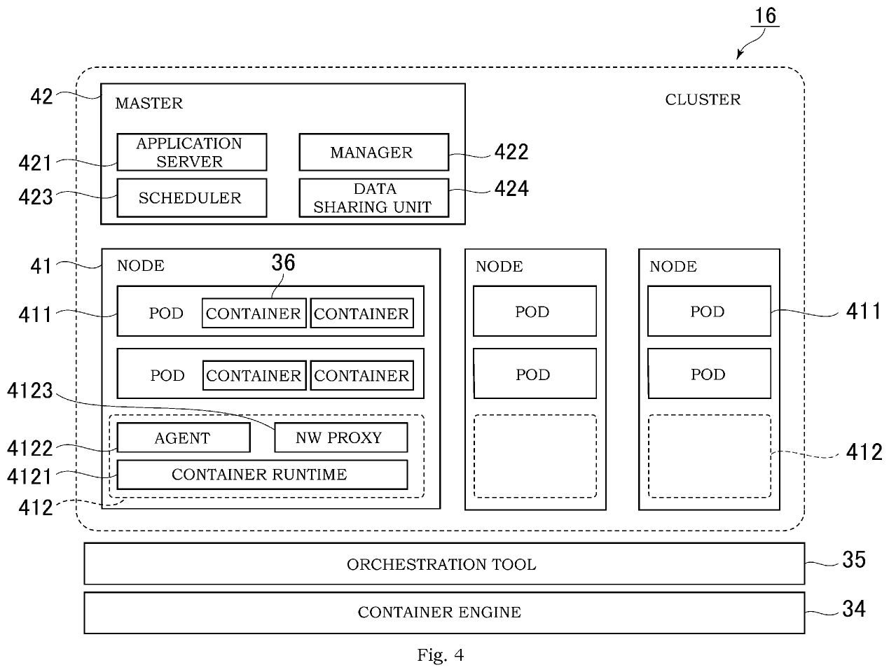

The orchestration tool 35 is a functional block that allows the container engine 34 to allocate the resources of the hardware 31 and the like. The orchestration tool 35 groups one or more containers 36 into a unit called a pod (not shown in FIG. 3), and each pod is deployed to a node (not shown in FIG. 3) that is a logically different area. Details of the operation by the orchestration tool 35 will be described later with reference to FIG. 4. The container engine 34 and the orchestration tool 35 may be referred to as middleware.

The container 36 includes middleware 38 such as a library as well as an application 37 that implements a predetermined function. The container 36 operates using the resources of the hardware 31 and the operating system 32 allocated by the container engine 34. Allocation of the resources to the container 36 by the container engine 34 is performed based on the configuration file included in the middleware 38 in the container 36 and the like. In this way, since resource management is guaranteed by the container engine 34, environment dependency of the operation of the container 36 can be reduced. The container 36 includes programs for applications such as machine learning, block chain, message service, and authentication service.

FIG. 4 is a schematic configuration diagram of the MEC 16, which is an operating environment of the container 36 when the orchestration tool 35 is used. The number of containers shown in this drawing is an example.

The orchestration tool 35 manages hardware resources allocated by the container engine 34. A logical space managed by the orchestration tool 35 is referred to as a cluster. In the present embodiment, the orchestration tool 35 uses the hardware resources of the MEC 16 to form the cluster.

The orchestration tool 35 manages an execution environment of the container 36 in a unit called a node 41. At the same time, the orchestration tool 35 is provided with a master 42 that manages operation of all nodes 41.

Two pods 411 are deployed on the node 41 in the example shown in this drawing. The pods 411 are functional blocks that are formed by a plurality of containers 36 and implement a predetermined service, and in the example shown in this drawing, each pod 411 includes two containers 36. The pod 411 is a unit under which the containers 36 are managed by the orchestration tool 35. Overall operation of the pods 411 in the node 41 is controlled by a pod management library 412.

The pod management library 412 includes a container runtime 4121 for causing the pods 411 (containers 36) to use the logically allocated hardware resources, an agent 4122 that accepts control from the master 42, and a network (NW) proxy 4123 via which the pods 411 or the node 41 and the master 42 or the like communicate with each other. According to the pod management library 412 with such a configuration, the pods 411 implement a predetermined function by using the hardware resources while communicating with the pod 411 in the same node 41 or a pod 411 of another node 41.

The master 42 includes an application server 421 that deploys the pods 411, a manager 422 that manages a deployment state of the containers 36 by the application server 421, a scheduler 423 that determines on which node 41 the container 36 is placed, a data sharing unit 424 that shares data, and the like. The master 42 can delete or deploy the pods 411 so that a processing load on each node 41 constituting the cluster becomes constant during operation of the edge system 10 in which the pods 411 is orchestrated. Therefore, high maintainability can be implemented.

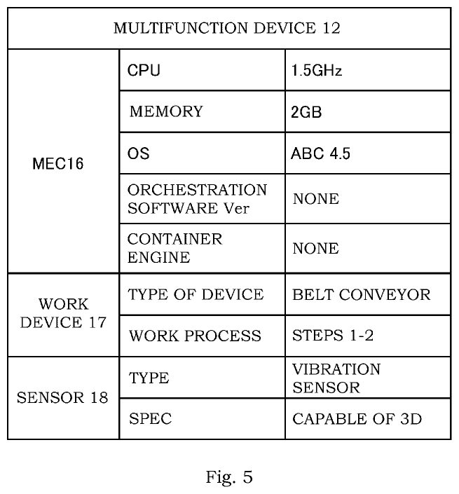

FIG. 5 is a table showing a profile configuration used for setting the multifunction device 12. This profile configuration is an example and may include other information.

In this drawing, as the profile configuration related to the multifunction device 12, hardware information regarding the MEC 16, the work device 17, and the sensor 18 constituting the multifunction device 12 is shown.

Information related to the MEC 16 includes general hardware information such as CPU (control unit 21) and memory (storage unit 22), as well as information such as installed OS, orchestration software, and container engine. The OS, the orchestration software, and the container engine may not be installed in the MEC 16 at an initial stage.

Information related to the work device 17 indicates a type of device and in which work process the work device 17 is used. In this example, it is shown that the work device 17 is to be used in steps 1-2 by a belt conveyor.

Information related to the sensor 18 indicates a type of sensor and specifications (specs) thereof. In this example, it is shown that the sensor 18 is a vibration sensor and is capable of measuring in three dimensions.

When the multifunction device 12 does not include the work device 17 or the sensor 18, configurations thereof are not described in the profile configuration, and it is shown that the work device 17, the sensor 18, and the like are not provided.

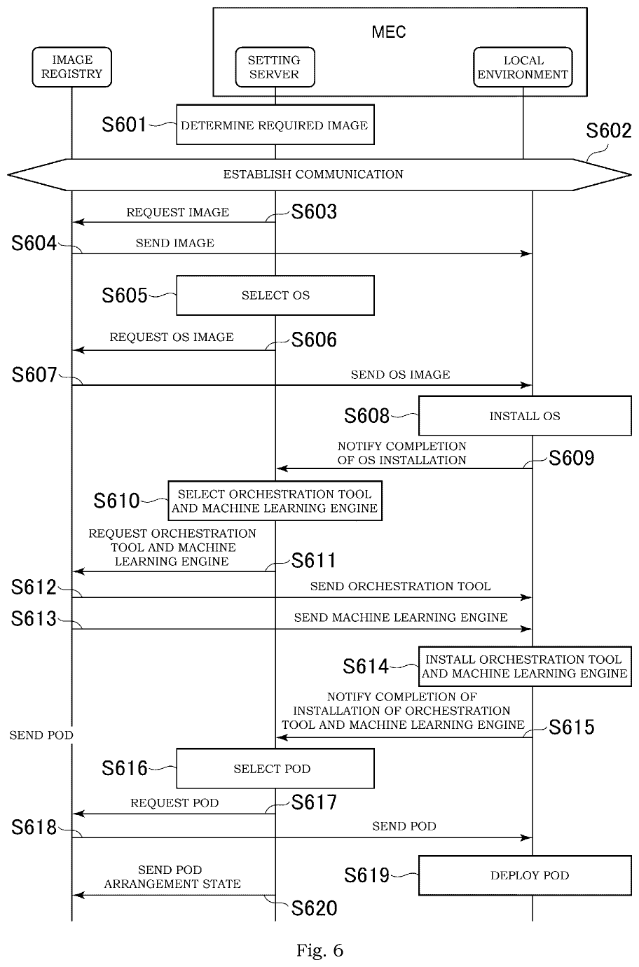

FIG. 6 is a flowchart showing setting control in initial setting of the MEC 16 by a setting server and the like. This setting control is performed by the image registry 15 and the MEC 16 in cooperation with each other. The MEC 16 is in a state where an OS and the like are not installed before the setting control, but it is assumed that the MEC 16 is equipped with a setting server that operates autonomously by using a PXE (Preboot eXecution Environment) function or the like. The setting server can start a boot loader on the MEC 16 via a network interface to perform predetermined setting control. In such a configuration, the MEC 16 acquires data from the image registry 15 mainly by the setting server, and builds an operating environment in the local environment in the MEC 16.

In step S601, the setting server determines required image files in the MEC 16 based on the stored profile configuration.

When the MEC 16 is not equipped with an OS, orchestration software, a container engine, and the like, the setting server determines that these programs are necessary. When these programs are not the latest version, the setting server determines that an update program to the latest program is required. Similarly, the setting server determines that it is necessary to deploy the pods 411 that execute a control program according to the type and process of the work device 17 and an analysis program according to the type and specifications of the sensor 18 to the MEC 16. The setting server appropriately determines a necessary file according to a configuration of the hardware 31 such as a CPU and a memory of the MEC 16.

In step S602, the setting server establishes a communication link between the image registry 15 and the MEC 16.

In step S603, the setting server requests, from the image registry 15, an image file related to software mainly used for controlling the hardware 31, such as a boot loader and a BIOS, among the necessary image files determined in step S601.

In step S604, the image registry 15 sends the image file in response to a request from the setting server to the MEC 16. By this process, the program used in the MEC 16 is also recognized in the image registry 15.

In step S605, when the setting server selects an image file of a required OS determined in step S601, the setting server requests the image file from the image registry 15 in step S606.

In step S607, the image registry 15 sends the image file of the OS in response to a request from the setting server to the MEC 16. By this process, the program used in the MEC 16 is also recognized in the image registry 15.

In step S608, the MEC 16 installs the OS in addition to the image file related to the control of the hardware 31 sent in step S604. Then, when installation of firmware and the OS is completed in the local environment, the MEC 16 sends a completion notification of the installation of the OS to the setting server in step S609.

When the OS of the MEC 16 is the latest, processes of steps S606 to S609 are omitted. When the OS of the MEC 16 is not the latest, the setting server sends an image file necessary for upgrading the OS.

In step S610, when the setting server selects an orchestration tool, a machine learning engine, and the like required for the MEC 16, the setting server requests image files thereof from the image registry 15 in step S611.

Then, the image registry 15 sends the orchestration tool to the MEC 16 in step S612, and sends the image files related to the machine learning engine and the like to the MEC 16 in step S613.

In step S614, when the installation of the orchestration tool and the machine learning engine is completed in the local environment, the MEC 16 notifies the setting server of the completion of the installation of the orchestration tool and the machine learning engine in step S615.

In step S616, when the setting server selects the pods 411 required for the MEC 16, the setting server requests image files thereof from the image registry 15 in step S617.

Then, in step S618, the image registry 15 sends the requested image file to the MEC 16, and in step S619, the pods 411 are deployed. Then, in step S620, the setting server sends a deployment state of the pods to the image registry 15. In this way, the operating environment of the container 36 when the orchestration tool 35 is used as shown in FIG. 4 is constructed.

In the present embodiment, the configuration file is stored in the MEC 16, but the present invention is not limited thereto. The configuration file may be stored in the image registry 15 on a network side. In such a case, the setting server of the MEC 16 may set an environment based on the configuration file stored in the image registry 15 after establishing communication with the image registry 15.

In this way, in the edge system 10, a setting process can be performed by installing the necessary image file in the MEC 16 from the image registry 15 based on the profile configuration stored in the MEC 16.

Such a setting process is not limited to setting in an initial state of the edge system 10, and may be performed when setting is changed. That is, when the profile configuration stored in the MEC 16 is modified, the setting server provided in the MEC 16 takes a lead in acquiring a necessary image from the image registry 15 and installing the necessary image in the local environment. When some functions can be diverted from a system configuration before the change in the setting change, it is not necessary to newly acquire an image from the image registry 15, so that the processing load and a communication load can be reduced. When a defect is found in the OS or the orchestration tool, the OS or the orchestration tool may be reinstalled by this setting process.

In the above-mentioned setting control, it is assumed that the setting server provided in the MEC 16 operates autonomously with no OS and middleware installed in the setting process, but the setting process is not limited thereto. When the setting of the edge system 10 is changed, a function equivalent to that of the setting server may be implemented by the pod 411. The pod 411, which has the function of the setting server, can change the container engine 34 and the orchestration tool 35 in addition to the container 36 when the setting is changed. Furthermore, unlike a memory operation on the OS and the middleware, the pod 411, which has the function of the setting server, can update programs related to the operating system 32 and the hardware 31 by directly specifying a physical address.

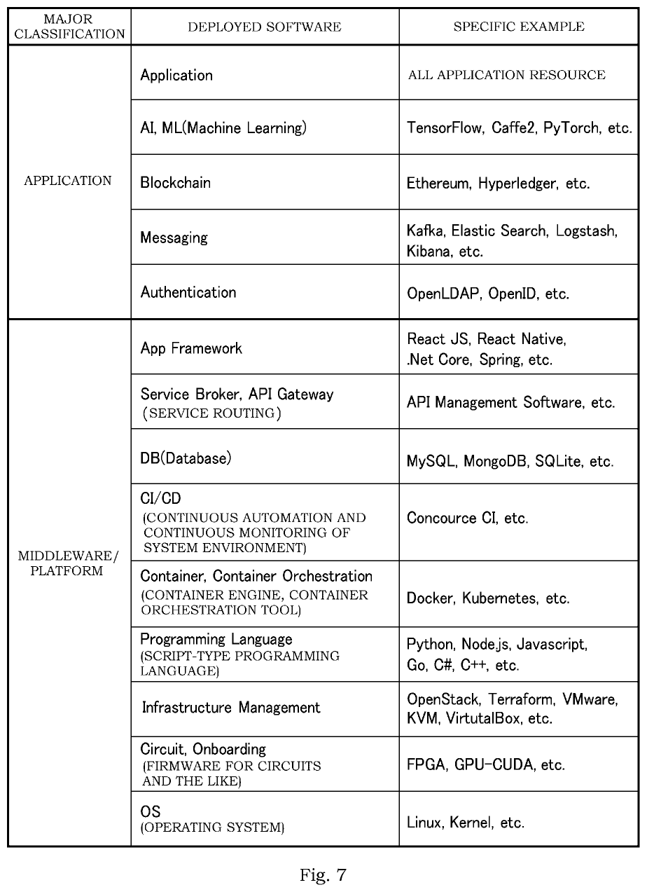

FIG. 7 shows a list of programs set by the setting process in the present embodiment. As shown in this drawing, the setting server largely controls configurations of the applications and the middleware/platform.

The applications include machine learning (AI, Machine Learning (ML), for example, TensorFlow, Caffe2, PyTorch, and the like), block chain (Blockchain, for example, Ethereum, Hyperledger, and the like), message service (Messaging, for example, Kafka, Elastic Search, Logstash, Kibana, and the like), and authentication service (Authentication, for example, OpenLDAP, OpenID, and the like), in addition to common applications.

The middleware/platform includes an application framework (App Framework, for example, React JS, React Native, .Net Core, Spring, and the like), a functional block that routes a service (Service Broker, API Gateway, for example, API Management Software, and the like), a database (DB (Database), for example, MySQL, MongoDB, SQLite, and the like), a functional block (CI/CD, for example, Concource CI, and the like) for continuous automation and continuous monitoring of a system environment, a container engine, a container orchestration tool (Container, Container Orchestration, for example, Docker, Kubernetes, and the like), a scripting programming language (programming language, for example, Python, Node.js, Javascript (Registered Trademark), Go, C#, C++, and the like), a functional block that manages infrastructure (Infrastructure Management, for example, OpenStack, Terraform, VMware, KVM, VirtutalBox, and the like), firmware for circuits and the like (Circuit, Onboarding, for example, FPGA, GPU-CUDA, and the like), and an operating system (OS, for example, Linux (Registered Trademark), Kernel, and the like).

These software shown in FIG. 7 can be deployed by the setting server according to the profile configuration shown in the configuration file during the initial setting, the setting change, or the like.

According to the first embodiment, the following effects can be obtained.

According to the edge system 10 of the first embodiment, the setting server of the MEC 16 determines a program required for setting the MEC 16 based on the setting information, and acquires an image corresponding to the program determined to be necessary from the image registry 15. Then, the program of the MEC 16 is set using the acquired image. With such a configuration, the setting of the MEC 16 only needs to use the setting information. Therefore, man-hours for installing a plurality of software are not required, and it is possible to reduce a risk of generating setting errors.

According to the edge system 10 of the first embodiment, the sensor 18 is provided integrally with the MEC 16, and the information related to the sensor 18 is stored in the setting information. In the edge system 10, various sensors 18 are used, and control programs thereof are different. However, by storing the information related to the sensor 18 in the setting information, the control program required by the sensor 18 can be installed in the MEC 16, so that man-hours for the initial setting can be reduced. During the setting change, the program of the MEC 16 can be updated by modifying the profile configuration, which makes it easier to manage the setting.

In the present embodiment, the edge system 10 is described as being configured by the multifunction device 12 including the MEC 16, the work device 17, and the sensor 18, but the present invention is not limited to such a configuration. Therefore, the edge system 10 may be configured as including only the MEC 16, or may be configured as the multifunction device 12 configured as a combination of the MEC 16 and any other configuration. The edge system 10 may be configured as a system including a plurality of the same or different multifunction devices 12.

### Second Embodiment

In the first embodiment, the edge system 10 configured by one multifunction device 12 is described, but the present invention is not limited thereto. In the present embodiment, the edge system 10 configured by a plurality of multifunction devices 12 constituting a parent-child relation will be described.

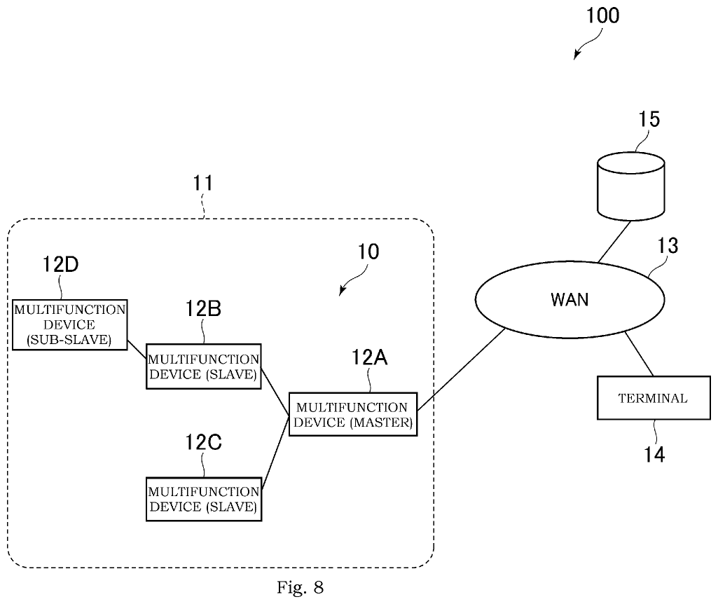

FIG. 8 is a block diagram showing a configuration of a monitoring system including an edge system according to an embodiment of the present invention.

As shown in this drawing, the edge system 10 is configured by the multifunction devices 12 that implement a plurality of functions such as communication and control. In the edge system 10, a second multifunction device 12B and a third multifunction device 12C of a second generation, which are slave units, are connected to a first multifunction device 12A of a first generation, which is a master unit. Further, the second multifunction device 12B is connected to a fourth multifunction device 12D of a third generation, which is a sub-slave unit.

In the present embodiment, an example in which the edge system 10 is configured by the multifunction devices 12 of three generations of the master unit, the slave unit, and the sub-slave unit is described, but the edge system 10 may be configured by the multifunction devices 12 of any number of generations. The number of the multifunction devices 12 that make up the edge system 10 may be any number.

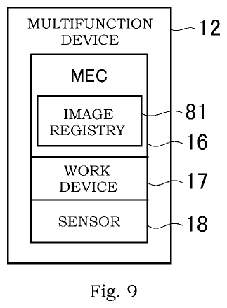

FIG. 9 is a diagram showing a detailed configuration of the multifunction device 12. According to this drawing, an image registry 81 is provided in the MEC 16. The image registry 81 has the same function as the image registry 15 on the cloud, and stores necessary image files.

In the following, an example of performing initial setting of an MEC 16B, which is a slave unit, using an image stored in an image registry 81A of an MEC 16A, which is a master unit, will be described.

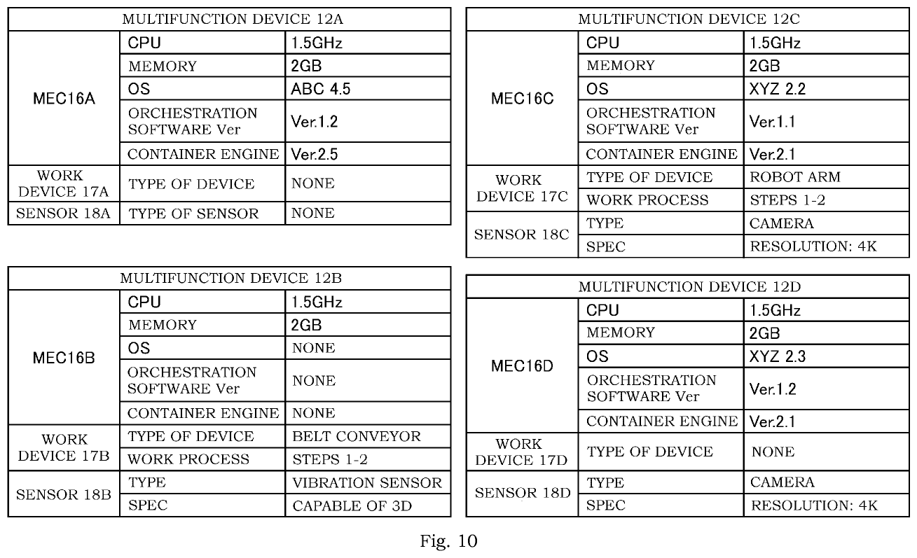

FIG. 10 is a table showing profile configurations of the multifunction devices 12 stored in the setting server. These profile configurations are examples and may include other information. The following describes an example in which the image registry 81A of the MEC 16A stores all image files required to configure the local environment, but the MECs 16A to 16D may each store the profile configuration.

In this drawing, as the profile configurations related to the multifunction devices 12A to 12D, hardware information regarding the MEC 16, the work device 17, and the sensor 18 constituting the multifunction device 12 is shown. Information regarding each of the multifunction devices 12A to 12D is equivalent to the profile configuration shown in FIG. 5 of the first embodiment.

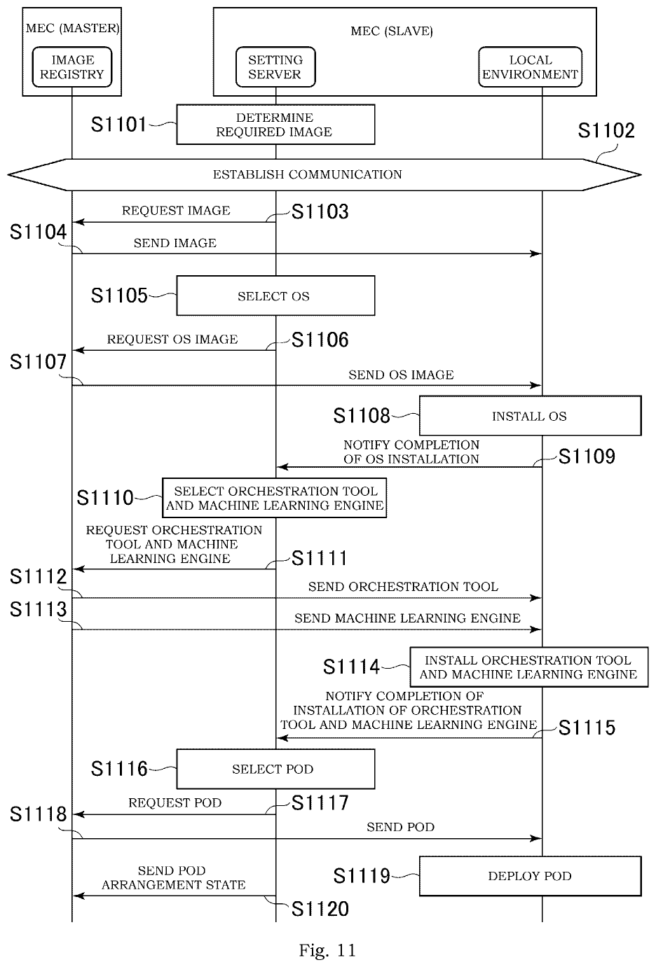

FIG. 11 describes setting of the MEC 16B, which is a slave unit, by the MEC 16A, which is a master unit. In a former stage of this process, it is assumed that the image registry 81A of the MEC 16A stores all image files necessary for configuring the local environment. That is, the same process as that between the image registry 15 and the MEC 16 in the setting control of the first embodiment is performed between the image registry 81A of the MEC 16A and the MEC 16B in setting control of the second embodiment.

In this setting control, processes of steps S1101 to S1120 correspond to steps S601 to S620 of the setting control shown in FIG. 6 in the first embodiment. Since the profile configurations of the MEC 16A to the MEC 16D are centrally managed in the MEC 16A, the MEC 16B acquires the profile configuration related to the MEC 16B from the MEC 16A in step S1101.

By configuring in this way, in each MEC 16B, the necessary image file can be acquired from the image registry 81A in the MEC 16A based on the profile configuration, and the setting can be performed using the image file.

Since the MEC 16B stores an image file required for setting in an image registry 81B of the MEC 16B, for example, if some functions fail and need to be reinstalled or redeployed, there is no need to communicate with the other image registry 81A of the MEC 16A or the image registry 15 on the network side. Therefore, time required for the reinstallation and redeployment can be shortened.

The processes of steps S1101 to S1120 shown in FIG. 11 do not need to be performed in an order of this example, and the order of these processes may be changed. As an example, the MEC 16B first determines a required image (S1101), selects an OS (S1105), selects an orchestration tool and a machine learning engine (S1110), and selects a pod 411 (S1116). After communication is established (S1102), the MEC 16B requests an image (S1103), an OS image (S1106), an orchestration tool and a machine learning engine (S1111), and a pod 411 (S1117). In response to these requests, the MEC 16A sends the required image (S1104), the OS image (S1107), the orchestration tool (S1112), the machine learning engine (S1113), and the pod 411 (S1118). Then, after acquiring these images, the MEC 16B installs the OS (S1108), installs the orchestration tool and the machine learning engine (S1114), deploys the pod 411 (S1119), and notifies completion of these installation (S1109, S1105). Finally, a setting server of the MEC 16B sends an arrangement state of the pod 411 to the MEC 16A (S1120).

By configuring in this way, by centrally performing the selection processes (S1101, S1105, S1110, S1116), requesting processes (S1103, S1106, S1111, S1117), sending processes (S1104, S1107, S1112, S1113, S1118), and installation processes (S1108, S1114, S1119) individually, time for performing the setting control can be shortened.

According to the second embodiment, the following effects can be obtained.

The edge system 10 of the second embodiment includes a plurality of MECs 16 having a parent-child relation, and each MEC 16 includes an image registry 81. With such a configuration, the MEC 16B, which is a slave unit, acquires the file required for the initial setting from the MEC 16A, which is a master unit. Therefore, for example, if some functions of the MEC 16B, which is a slave unit, fail and need to be reinstalled or redeployed, since it is not necessary to communicate with the image registry 81A of the MEC 16A, which is a master unit, or the image registry 15 on the network side, time required for the reinstallation and redeployment can be shortened.

Although the embodiments of the present invention have been described above, the above-mentioned embodiments are merely a part of application examples of the present invention, and do not mean that the technical scope of the present invention is limited to a specific configuration of the above-described embodiments.

### REFERENCE SIGNS LIST

10 edge system

11 local environment

12 multifunction device

15, 81 image registry

16 MEC (edge terminal)

17 work device

18 sensor

100 monitoring system

1. An edge system configured by an edge terminal that implements a predetermined function by operating a container using a hardware resource logically allocated by an orchestration technique, wherein
the edge terminal is configured to
acquire a corresponding image from an image registry based on predetermined setting information, and
perform a setting process of deploying to the edge terminal using the acquired image
the edge terminal further includes a device having a predetermined function, and
the setting information includes information related to the device.

2. (canceled)

3. The edge system according to claim 1, wherein
the device is a sensor, and
the edge terminal performs deployment using an image corresponding to the sensor.

4. The edge system according to claim 1, wherein
the image registry is connected to the edge system via a network.

5. The edge system according to claim 1, wherein
the edge system is configured by a plurality of the edge terminals, and
the image registry is included in the edge terminal.

6. The edge system according to claim 5, wherein
one of the edge terminals is configured to
acquire a corresponding image from the image registry of another edge terminal among the edge terminals based on the setting information.

7. The edge system according to claim 6, wherein
the one edge terminal and the other edge terminal have a parent-child relation.

8. A method for controlling an edge system configured by an edge terminal that implements a predetermined function by operating a container using a hardware resource logically allocated by an orchestration technique, the method comprising:
a step of acquiring, by the edge terminal, a corresponding image from an image registry based on predetermined setting information; and
a step of performing, by the edge terminal, a setting process of deploying to the edge terminal using the acquired image,
wherein
the edge terminal further includes a device having a predetermined function, and the setting information includes information related to the device.

9. A computer program used for controlling a method for controlling an edge system configured by an edge terminal that implements a predetermined function by operating a container using a hardware resource logically allocated by an orchestration technique, the computer program used for controlling the edge system comprising:
causing the edge terminal to execute
a step of acquiring a corresponding image from an image registry based on predetermined setting information; and
a step of performing a setting process of deploying to the edge terminal using the acquired image,
wherein
the edge terminal further includes a device having a predetermined function, and
the setting information includes information related to the device.

10. (canceled)
